(19) United States
(12) Patent Application Publication
(10) Pub. No.: US 2001/0027721 A1
(43) Pub. Date: Oct. 11, 2001

(54) Hollow piston for compressor

(76) Inventors: Takayuki Kato, Aichi-ken (JP); Seiji Katayama, Aichi-ken (JP); Takahiro Hoshida, Aichi-ken (JP); Fuminobu Enokijima, Aichi-ken (JP)

Correspondence Address: Steven J. Rocci, Esq., WOODCOCK WASHBURN KURTZ, MACKIEWICZ & NORRIS LLP, One Liberty Place- 46th Floor, Philadelphia, PA, 19103, US

(21) Appl. No.: 09/781,458

(22) Filed: Feb. 12, 2001

(30) Foreign Application Priority Data
Feb. 16, 2000 (JP) 2000-038329
Feb. 18, 2000 (JP) 2000-041658

(51) Int. Cl. F16J 1/00

(52) U.S. Cl. 92/260; 92/172

(57) ABSTRACT

A hollow head portion of the piston is provided with a bottomed cylindrical portion and a cap closing an opening of the bottomed cylindrical portion. The cap is in the form of bottomed cylinder including a bottom wall, a cylindrical large diameter portion and a cylindrical small diameter portion. An outer circumferential surface of the small diameter portion is fitted to an inner circumferential surface of the cylinder portion of the bottomed cylindrical portion so that end faces are contacted with each other, and then these end faces are connected to each other by welding. A cap length, which is an axial distance from an apex surface of the cap to the end face thereof is set to be larger than a thickness of the bottom wall so that the welded portion is located far from a boundary portion between the bottom wall and the large diameter portion.

### BACKGROUND OF THE INVENTION

1. Field of the Invention

The present invention relates to a piston for a compressor, and in particular to such a piston that at least a head portion thereof to be fitted into a cylinder bore is hollow.

2. Description of the Related Art

A piston for a compressor is reciprocated by a reciprocating drive device to compress the refrigerant gas. In general, the piston of this type has a head portion to be fitted to a cylinder bore, and an engagement portion to be engaged with the reciprocating drive device. Since the piston makes a reciprocating motion, it is desired to be reduced in weight. For this reason, at least the head portion to be fitted into the cylinder bore is made hollow. Known as one of methods manufacturing this hollow piston head portion is providing a piston main body member (a) and a disk-like closure member (b), and connecting these piston main body and closure member together. The piston main body is integrally formed with a bottomed cylindrical portion, which has a bottom wall and a cylinder portion axially extending from an outer peripheral portion of the bottom wall, and an engagement member that is integral with the bottom wall of the bottomed cylindrical portion and that is to be engaged with the reciprocating drive device. The closure member is designed to close the bottomed cylindrical portion of the piston main body. To connect these members, a welding, a frictional pressure-contact, an adhesion, a physical connecting means (for example, a caulking) and the like are available, and some of these connecting methods are put into practice.

The hollow piston manufactured by the method of this type, however suffers from a problem in that the weight of the hollow piston cannot be reduced satisfactorily since a sufficient connection strength must be secured. During the compression process in use of the hollow piston, the pressure of the compressed gas acts on the closure member, and deforms the closure member so that it is convexed into the interior of the hollow head portion three-dimensionally. During the suction process, the inertial force acts on the closure member, and deforms the closure member so that it is convexed toward the exterior of the hollow head portion three-dimensionally. These deformations cause a stress concentration onto the connection portion between the cylinder portion of the piston main body member and the closure member, which lowers the durability of the hollow piston. For this reason, the closure member is required to be thick in order to suppress these deformations. In a case where the connection is realized by welding, frictional pressure-contact, adhesion or the like, the welding area, the pressure-contact area, the adhered area or the like must be increased in order to increase the connection strength. Accordingly, in addition to the necessity of making the thickness of the cylinder portion of the piston main body member relatively thicker, this also hinders the hollow piston to be sufficiently reduced in weight.

### SUMMARY OF THE INVENTION

In view of the problems encountered in the related art, an object of the present invention is aimed at further reducing the weight of a hollow piston for a compressor while securing the durability of the hollow piston.

According to the present invention is to provide a hollow piston for a compressor, comprising: (a) a piston main body member including a bottomed cylindrical portion and an engagement portion to be engaged with a reciprocating drive device, the bottomed cylindrical portion having a bottom wall and a cylinder portion extending axially from an outer circumferential portion of the bottom wall, the engagement portion being integral with the bottom wall of the bottomed cylindrical portion; and (b) a closure member connected to the piston main body member to close the bottomed cylindrical portion of the piston main body member, thereby defining a hollow head portion of a substantially hollow cylindrical shape integral with the engagement portion, characterized in that, the closure member is in the form of a bottomed cylindrical shape including a bottom wall, and a cylinder portion extending axially from an outer circumferential portion of the bottom wall of the closure member, both of the cylinder portions are connected to each other in a state in which an end surface of the cylinder portions of the closure member is contacted with an end surface of the cylinder portion of the piston main body member, and a length of the closure member, which is a distance from an outer end surface of the bottom wall of the closure member to the end surface of the cylinder portion of the closure member is larger than a thickness of the bottom wall of the closure member, and is less than ½ of an axial length of the hollow head portion.

In this manner, the cylinder portion is provided to the closure member in addition to the cylinder portion of the piston main body member, and the end surface of the cylinder portion of the closure member is contacted with the end surface of the cylinder portion of the piston main body member, and in this state both of the cylinder portions are connected to each other. As described later in detail in the “Detailed Description of the Preferred Embodiment”, the connected portion is located far from the portion where the stress is likely to be concentrated during the elastic deformation of the bottom wall of the closure member, and further the formation of the cylinder portion increases the rigidity of the closure member. Accordingly, it is possible to reduce the thickness of the bottom wall of the closure member and the thickness of the circumferential wall of the cylinder portion of the piston main body member while securing durability of the hollow piston.

The closure member may comprise a cylindrical fitting portion extending axially from an end surface inner circumferential portion of the cylinder portion, and an outer circumferential surface of the fitting portion may be fitted to an inner circumferential surface of the cylinder portion of the piston main body member.

By fitting the closure member to the inside of the fitting portion in this manner, a relative positional alignment between the piston main body member and the closure member is facilitated, and thus connection between these members becomes easy. Further, in the case where the connection is achieved by adhesion or welding, not only the end surfaces of the cylinder portions, but also the outer circumferential surface of the fitting portion of the closure member and the inner circumferential surface of the piston main body member can be adhered or welded to each other. This makes it possible to further increase the connection strength between the piston main body member and the closure member.

The end surface of the cylinder portion of the piston main body member and the end surface of the cylinder portion of the closure member may be welded to each other.

Since the welded portion is far from the stress concentration portion, it is possible to reduce the weight while securing the durability. The welding is preferably performed to reach an inner circumferential edge of the cylinder portions. In the case where the inner circumferential portions of the end surfaces of the cylinder portions are not welded, the non-welded portion acts as if a crack is present, and consequently, the welded portion is damaged easily.

The end surface of the cylinder portion of the piston main body member and the end surface of the cylinder portion of the closure member may be adhered to each other, and the outer circumferential surface of the fitting portion may be adhered to the inner circumferential surface of the cylinder portion of the piston main body member.

Since the adhered portion is far from the stress concentration portion, the stress acting on the adhesive agent layer is small, thereby making it possible to reduce the weight while securing the durability as described above.

By a low melting point material lower in melting point than materials of the piston main body member and closure member, the end surface of the cylinder portion of the piston main body member and the end surface of the cylinder portion of the closure member may be joined to each other, and the outer circumferential surface of the fitting portion may be joined to the inner circumferential surface of the cylinder portion of the piston main body member.

The piston main body member may comprise a cylindrical fitting portion extending axially from an outer circumferential portion of the end surface of the cylinder portion of the bottomed cylindrical portion, and an inner circumferential surface of the fitting portion and an outer circumferential surface of the closure member may be fitted to each other.

By an adhesive agent, the end surface of the cylinder portion of the piston main body member and the end surface of the cylinder portion of the closure member may be adhered to each other, and the inner circumferential surface of the fitting portion may be adhered to the outer circumferential surface of the closure member.

An outer end surface circumferential edge of the bottom wall of the closure member may be chamfered to provide a chamfered portion, and a leading end portion of the fitting portion may be caulked onto the chamfered portion.

A length of the closure member may be 1.5 times or more, or 2 times or more of a thickness of the bottom wall of the closure member.

As the length of the closure member is longer, the connected portion farthers away from the stress concentration portion, and the stress acting on the connected portion may be closer to the simple compression stress or tensile stress, and further the rigidity of the closure member becomes higher. Accordingly, the durability of the connected portion is increased, and the effect of the present invention becomes more remarkable. Note, however, that the ratio of increasing the effect is gradually decreased as the length of the closure member is longer, and the closure member longer in length results in the increase in force acting on the closure member due to the friction or the like between the outer circumferential surface of the hollow head portion and the inner circumferential surface of the cylinder bore, thus resulting in the increase in stress acting on the connected portion. In view of these facts, it is not preferable to set the length of the closure member to be ½ or more of the axial length of the hollow head portion. In general, it is preferably set to be 4 times or less of the thickness of the bottom wall, and more preferably set to be 3 times or less thereof.

A corner at an intersection between an inner surface of the bottom wall of the closure member in the form of the bottomed cylindrical shape and an inner circumferential surface of the cylinder portion thereof may be rounded.

The stress is concentrated on the corner portion, and therefore it is preferable to round the corner portion to avoid the generation of the crack caused due to the stress concentration.

According to the present invention is to provide a method of manufacturing a hollow piston for a compressor, the hollow piston having an engagement portion to be engaged with a reciprocating drive device and a hollow head portion of a substantially hollow cylindrical shape, the method comprising the steps of: forming the piston main body member including a bottomed cylindrical portion and an engagement portion, the bottomed cylindrical portion having a bottom wall and a cylinder portion extending axially from an outer circumferential portion of the bottom wall, the engagement portion being integral with the bottom wall of the bottomed cylindrical portion; forming the closure member including a bottom wall and a cylinder portion extending axially from an outer circumferential portion of the bottom wall, a length of the closure member, which is a distance from an outer end surface of the bottom wall of the closure member to the end surface of the cylinder portion of the closure member, being larger than a thickness of the bottom wall of the closure member and; connecting both of the cylinder portions to each other in a state in which an end surface of the cylinder portion of the closure member is contacted with an end surface of the cylinder portion of the piston main body member, the length of the closure member being less than ½ of an axial length of the hollow head portion.

### BRIEF DESCRIPTION OF THE DRAWINGS

In the accompanying drawings:

FIG. 1 is a front sectional view showing a swash plate compressor provided with a compressor hollow piston which constitutes an embodiment of the present invention;

FIG. 2 is a front sectional view of the hollow piston;

FIG. 3 is a front view (partially in section) showing piston main body members and closure members that constitute a piston manufacturing material from which the hollow piston is obtained;

FIG. 4 is a front sectional view for explaining a method of manufacturing the hollow piston;

FIG. 5 is a front sectional view showing a part of a compressor hollow piston which constitutes another embodiment of the present invention;

FIG. 6 is a front sectional view showing a part of a compressor hollow piston which constitutes further another embodiment of the present invention;

FIG. 7 is a front sectional view showing a part of a compressor hollow piston which constitutes further another embodiment of the present invention; and

FIGS. 8 and 9 are front sectional views showing a part of a compressor hollow piston which constitutes further another embodiment of the present invention.

### DETAILED DESCRIPTION OF THE PREFERRED EMBODIMENTS

### Embodiment 1

An example of a hollow piston, which is used for a swash-plate compressor in an automotive air conditioning device and constitutes an embodiment of the present invention, will be described with reference to the accompanying drawings.

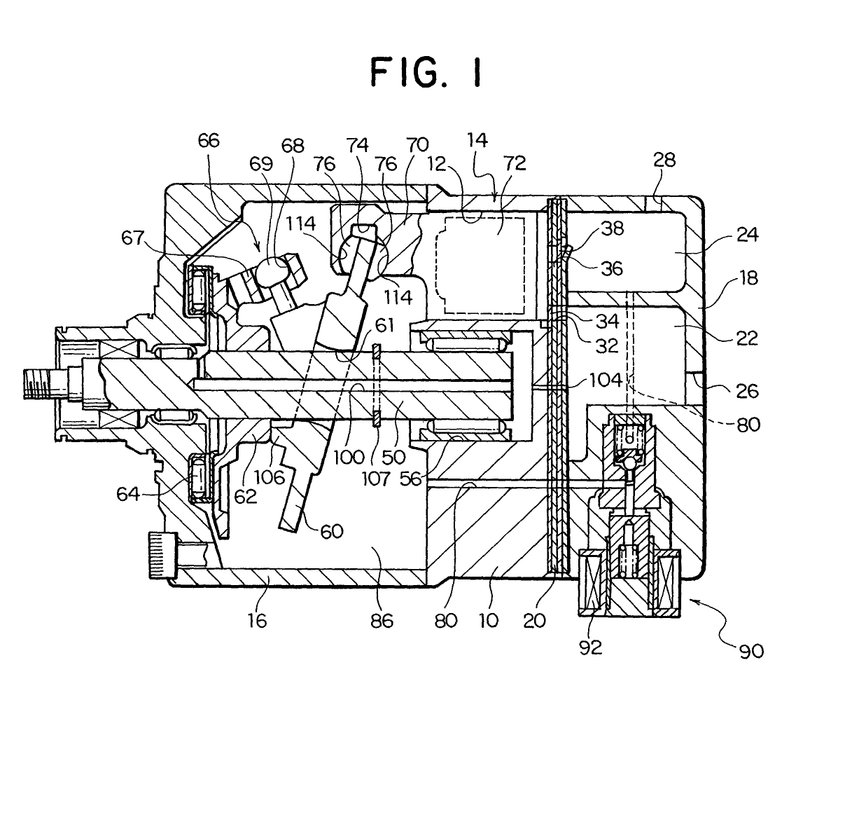

FIG. 1 shows a swash-plate compressor according to the present embodiment. In FIG. 1, a reference numeral 10 denotes a cylinder block. A plurality of cylinder bores 12 are located on a circumference about a central axis of the cylinder block 10 and extend axially. In each of the cylinder bores 12, a single-headed piston 14 (hereafter referred to simply as a piston 14) is disposed to make a reciprocating motion. A front housing 16 is attached to one end surface of the cylinder block 10 in the axial direction (i.e. the left side end surface in FIG. 1, referred to as a front end surface), and a rear housing 18 is attached via a valve plate 20 to the other end surface (the right side end surface in FIG. 1, referred to as a rear end surface). The front housing 16, the rear housing 18, the cylinder block 10 constitute a housing assembly of the swash-plate compressor. A suction chamber 22 and a discharge chamber 24 are defined between the rear housing 18 and the valve plate 20, which are respectively connected through an inlet 26 and a outlet 28 to a refrigerating circuit not shown. The valve plate 20 is provided with suction ports 32, suction valves 34, discharge ports 36, discharge valves 38 and the like.

A rotary shaft 50 is rotatably provided to extend on and along the central axis of the cylinder block 10. The rotary shaft 50 is supported at its ends through bearings to the front housing 16 and the cylinder block 10. A central support hole 56 is formed through a central portion of the cylinder block 10, and the rotary shaft 50 is supported to the central support hole 56. The front housing 16 side end portion of the rotary shaft 50 is connected via a clutch mechanism such as an electromagnetic clutch to an unillustrated automotive engine serving as an external drive source. Therefore, when the engine is started to connect the rotary shaft 50 to the engine through the clutch mechanism, the rotary shaft 50 per se is rotated about its own axis.

A swash plate 60 is attached to the rotary shaft 50 relatively movably in the axial direction and inclinably. The swash plate 60 is formed with a central through hole 61 passing through the central line, and the rotary shaft 50 is allowed to penetrate the central through hole 61. The central hole 61 has a gradually increasing diameter at each open end thereof. A rotary disk 62, serving as a rotation transmitting member, is fixed to the rotary shaft 50, and engaged with the front housing 16 via a thrust bearing 64. By a hinge mechanism 66, the swash plate 60 is rotated integrally with the rotary shaft 50, and permitted to be inclined along with the axial movement thereof. The hinge mechanism 66 includes a pair of support arms 67 fixedly provided to the rotary disk 62, a pair of guide pins 69 fixedly provided to the swash plate 60 and slidably fitted to a pair of guide holes 68 of the respective support arms 67, the central hole 61 of the swash plate 60, and an outer circumferential surface of the rotary shaft 50. In the present embodiment, the swash plate 60 serving as a drive member, the rotary shaft 50, the hinge mechanism 66 constituting the rotation transmitting device, etc. contribute a reciprocating drive device for reciprocatingly moving the piston 14.

The piston 14 is designed as a hollow piston, and includes an engagement portion 70 for engagement with the swash plate 60, and a hollow head portion 72 provided integrally with the engagement portion 70 and fitted into the cylinder bore 12. The swash plate 60 is engaged with a groove 74 formed in the engagement portion 70 through a pair of semi-spherical shoes 76. The semi-spherical shoes 76 have spherical portions slidably held by the engagement portion 70, and planar portions that are contacted with the respective surfaces of the swash plate 60 to slidably hold and clamp the outer circumferential portion of the swash plate 60 therebetween. The shape of the piston 14 will be described in detail later.

The rotational motion of the swash plate 60 is converted, through the shoes 76, into the linear reciprocating motion of the piston 14. During the suction process in which the piston 14 is moved from an upper dead center to a lower dead center, the refrigerant gas within the suction chamber 22 is sucked via the suction port 32 and the suction valve 34 into the cylinder bore 12. During the compression process in which the piston 14 is moved from the lower dead center to the upper dead center, the refrigerant gas in the cylinder bore 12 is compressed and then discharged via the discharge port 36 and the discharge valve 38 to the discharge chamber 24. In association with the compression of the refrigerant gas, the axial compression reaction force acts on the piston 14. The compression reaction force is received through the piston 14, the swash plate 60, the rotary plate 62 and the thrust bearing 64 by the front housing 16. The engagement portion 70 of the piston 14 is provided with a rotation preventive portion (not shown) integrally. The rotation preventive portion, when contacted with the inner circumferential surface of the front housing 16, restricts the rotation of the piston 14 about the central axis to avoid the interference between the piston 14 and the swash plate 60.

A supply passage 80 is provided to penetrate through the cylinder block 10. By this supply passage 80, the discharge chamber 24 is connected to an swash plate chamber 86 formed between the front housing 16 and the cylinder block 10. A capacity control valve 90 is provided at a midway of the supply passage 80. The capacity control valve 90 is an electromagnetic valve, and a solenoid 92 is energized and de-energized by a control device (not shown) mainly constructed by a computer. Depending on information of the cooling load, etc., the supplied current value is controlled, to thereby adjust the opening degree of the capacity control valve 90.

A bleeding passage 100 is provided in the interior of the rotary shaft 50. The bleeding passage 100 is opened to the central support hole 56 at one end thereof, and opened to the swash plate chamber 86 at the other end thereof. The central support hole 56 is communicated via a communication bore 104 with the suction chamber 22.

The swash-plate compressor according to the present embodiment is designed as a variable capacity type, and uses the discharge chamber 24 and the suction chamber 22 as a high pressure source and a low pressure source, respectively, so that a pressure difference therebetween is utilized to control the pressure within the swash plate chamber 86. This adjusts a pressure difference between the pressure in the cylinder bore 12 serving as the compression chamber and the pressure in the swash plate chamber 86,which are respectively acting on the front and rear of the piston 14, to thereby change an inclined angle of the swash plate 60, change the stroke of the piston 14 and adjust the discharge capacity of the compressor. More specifically, under the control of the capacity control valve 90, the swash plate chamber 86 is selectively communicated with and isolated from the discharge chamber 24 so that the pressure in the swash plate chamber 86 is controlled. In the de-energizing state of the solenoid 92, the capacity control valve 90 is fully opened so that the supply passage 80 is put into a communicated state, in which the high pressure refrigerant gas in the discharge chamber 24 is supplied to the swash plate chamber 86. Accordingly, the pressure within the swash plate chamber 86 is higher and thus the inclined angle of the swash plate 60 is minimal. When the inclined angle of the swash plate 60 is minimal, the capacity varying ratio of the piston 14, which is reciprocatingly moved in association with the rotation of the swash plate 60, is small, and thus the discharge capacity of the compressor is minimal. In the energizing state of the solenoid 92, as the opening degree of the capacity control valve 90 is smaller (including zero) by increasing the supplied current value, the supplied quantity of the high pressure refrigerant gas in the discharge chamber 24 to the swash plate chamber 86 is smaller, and the refrigerant gas within the swash plate chamber 86 is released via the bleeding passage 100 and the communication bore 104 to the suction chamber 22. Accordingly, the pressure in the swash plate chamber 86 is reduced. In association therewith, the inclined angle of the swash plate 60 is made larger to increase the capacity varying ratio of the piston 14, thereby increasing the discharge capacity of the compressor. When the supply passage 80 is interrupted due to the energizing of the solenoid 92, the high pressure refrigerant gas in the discharge chamber 24 is not supplied to the swash plate chamber 86, so that the inclined angle of the swash plate 60 is maximum. Accordingly, the discharge capacity of the compressor becomes maximum. The maximum inclined angle of the swash plate 60 is defined by the contact of a stopper 106 provided to the swash plate 60 with the rotary plate 62, and the minimal inclined angle is defined by the contact of the swash plate 60 with a stopper 107 provided onto the rotary shaft 50. The supply passage 80, the swash plate chamber 86, the capacity control valve 90, the bleeding passage 100, the communication bore 104, the control device, etc. constitute an swash plate inclination control device or a discharge capacity control device.

Each of the cylinder block 10 and the piston 14 is made of an aluminum alloy, that is a kind of a metal, and the outer circumferential surface of the piston 14 is coated with a fluorine resin. The coating of the fluorine resin avoids the direct contact between the same metal members, thereby preventing seizing while permitting a fitting clearance to the cylinder bore 12 to be set to a possible minimal level. In addition, each of the cylinder block 10 and the piston 14 is preferably made of an aluminum-silicon-group alloy or the like. Note, however, that the material for the cylinder block 10 and the piston 14, the material for the coating layer and the like are not limited to those described above, and other materials may be used.

The piston 14 will be described in more detail.

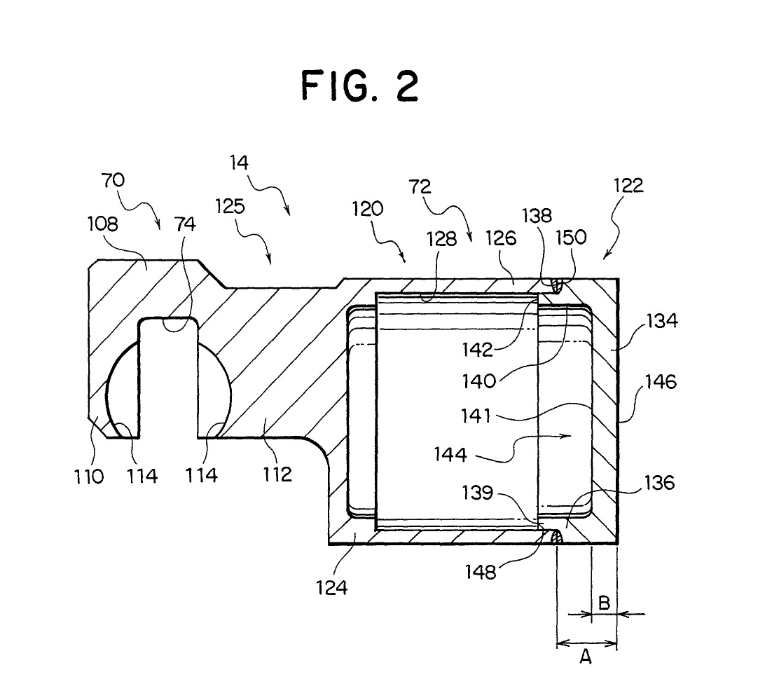

As shown in FIG. 2, the end portion of the engagement portion 70 of the piston 14, remote from the head portion 72, is formed substantially into a U-shape due to the provision of the groove 74, and has a base portion 108 forming a bottom portion of the U-shape, and a pair of arm portions 110 and 112 extending from the base portion 108 in a direction perpendicular to the axis line of the piston 14. Mutually opposing side surfaces of the arm portions 110 and 112 are respectively formed with recessed portions 114. The inner surfaces of these recessed portions 114 are formed as concave spherical surfaces. The aforementioned pair of shoes 76 are contacted with the both surfaces of the outer circumferential portion of the swash plate 60 to hold and clamp the swash plate 60 therebetween, and held by the recessed portions 114.

The head portion 72 of the piston 14 is provided with the bottomed cylindrical portion 120 presenting a bottomed cylindrical shape opened at one end thereof, and closed at the other end thereof, and a cap 122 serving as the closure member for closing the opening of the bottomed cylindrical portion 120 and fixed to the bottomed cylindrical portion 120. The bottomed cylindrical portion 120 has a bottom wall 124 that is formed integrally with the arm portion 112 side of the engagement portion 70. These bottomed cylindrical portion 120 and the engagement portion 70 constitute the integral piston main body member 125. The bottomed cylindrical portion 120 is provided with a cylinder portion 126 extending from the outer circumferential portion of the bottom wall 124 in the axial direction. The bottom wall 124 constitutes a closure portion for closing the other end of the cylinder portion 126. The inner circumferential surface 128 of the bottomed cylindrical portion 120 is formed as a simple cylindrical surface.

The cap 122 is formed in a bottomed and stepped cylindrical Shape, which has a planar plate-like bottom wall 134, a large diameter portion 136 axially extending from the outer circumferential portion of the bottom wall 134, and a small diameter portion 139 axially extending from the inner circumferential portion of the end surface 138 of the large diameter portion 136. The inner circumferential surface 140 of the small diameter portion 139 and the large diameter portion 136, and the inner surface 141 of the bottom wall 134 form a recessed portion 144 located in the interior of the cap 122 and opened toward the end surface 142 of the small diameter portion 139, thereby reducing the weight. In addition, a rounded corner is formed at the intersection between the inner circumferential surface 140 of the recessed portion 144 and the inner surface 141 of the bottom wall 134 as shown in FIG. 2, thereby increasing the rigidity of the boundary between the large diameter portion 136 and the bottom wall 134. A cap length A, that is, an axial length from the apex surface 146, i.e. the outer end surface of the bottom wall 134 to the end surface 138 of the large diameter portion 136 is set to be larger than the thickness B of the bottom wall 134. For example, it is preferable to set the cap length A to be 1.5 times of the thickness B of the bottom wall 134 or more, or more preferably 2 times or more. In more specific, if B is 3 mm, then A is preferably 5 mm or more, and more preferably 7 mm or more. Further, the cap length A is set to be not more than ½ of the axial length of the head portion 72. In FIG. 2, the circumferential wall thickness of the cylinder portion 126, the circumferential wall thickness of the large diameter portion 136, the thickness of the bottom wall 134 and the like are illustrated in an exaggeration manner for the purpose of facilitating the understanding.

The outer circumferential surface 148 of the small diameter portion 139 of the cap 122 is fitted to the inner circumferential surface 128 of the bottomed cylindrical portion 120 up to such a depth that the end surface 138 is contacted with the open side end surface 150 of the bottomed cylindrical portion 120, and the open side end surface 150 and the end surface 138 are welded as the welding surfaces together so that the cap 122 and the piston main body member 162 are joined to each other. The welded portion between the end surface 138 and the open side end surface 150 receives the compression reaction force of the refrigerant gas acting on the apex surface 146 of the head portion 72 during compression process of the piston 14.

In the present embodiment, the piston 14 constructed as describe above is manufactured such that two pistons 14 are obtained from a single piston material. Accordingly, a single-headed piston manufacturing material 160 for manufacturing the pistons 14 (hereafter, referred to simply as the material 160) is provided with the piston main body members 162 (hereafter, referred to simply as the main body members 162) and the caps 164 serving as the closure members. Each of the main body members 162 has the engagement portion 166, and the bottomed cylindrical portion 170 opened opposite from the engagement portion 166. The two main body members 162 are formed integrally such that the bottomed cylindrical portions 170 are concentric to each other and the engagement portion 166 sides are adjacent to each other.

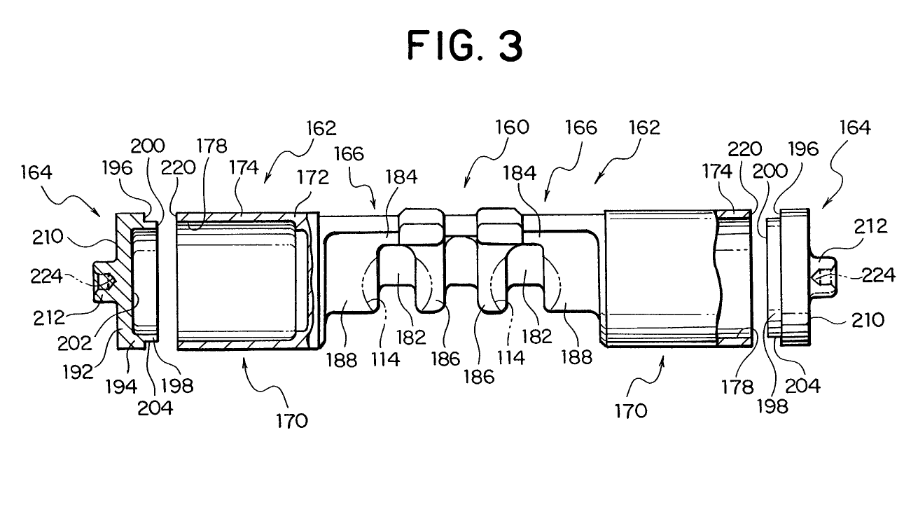

The bottomed cylindrical portion 170 has the bottom wall 172, and the cylinder portion 174 extending axially from the outer circumferential portion of the bottom wall 172, and is formed at the bottom wall 172 integrally with the engagement portion 166. The inner circumferential surface 178 of the cylinder portion 174 is formed as a simple cylindrical surface. The inner circumferential surface 178 corresponds to the inner circumferential surface 128 of the piston 14 manufactured as a product. A bridge portion 182 provided to each of the engagement portions 166 connects the inner side surfaces of the portions corresponding to the base portion 108 and the arm portions 110 and 112 (referred to as a base portion 184, arm portions 186 and 188, respectively) as shown in FIG.3 in order to reinforce the engagement portion 166 against the clamping action during the processing. That is, the bridge portion 182 is provided as a reinforcing portion for increasing the rigidity of the main body member 162 or suppressing thermal strain. In the present embodiment, the main body member 162 is made of an aluminum alloy which is a kind of a metal, and manufactured by casting or forging. The casting includes various die casts such as a sand casting, a metal die casting, a vacuum process, a PF (pore free die casting) process, and a rheocasting process, and a molten metal casting. The forging includes a general forging, a semi-solid forging (SSF), and the like.

The two caps 164 are constructed similarly, so that one of the two caps 164 is discussed as a representative example. As shown in FIG. 3, the cap 164 is formed as a bottomed and stepped cylindrical shape, which has a planar plate-like bottom wall 192, a large diameter portion 194 axially extending from the outer circumferential portion of the bottom wall 192, and a small diameter portion 198 axially extending from the inner circumferential portion of the end surface 196 of the large diameter portion 194. The inner circumferential surface of the small diameter portion 198 and the large diameter portion 194, and the inner surface of the bottom wall 192 form a recessed portion 202 located in the interior portion of the cap 164 and opened toward the end surface 200 of the small diameter portion 198, thereby reducing the weight. The recessed portion 202 corresponds to the recessed portion 144 of the piston 14 manufactured as a product. The diameter of the outer circumferential surface 204 of the small diameter portion 198 is set to be smaller than the outer diameter of the large diameter portion 194 so as to be fittable to the inner circumferential surface 178 of the bottomed cylindrical portion 170. In the illustrated example, a holder portion 212 circular in section is protrudingly provided on the central portion of the end surface 210 of the cap 164 opposite from the small diameter portion 198 side end surface 200. The thickness of the bottom wall 192 of the cap 164, and the cap length, i.e. the axial distance from the end surface 210 of the bottom wall 192 to the end surface 196 of the large diameter portion 194 are set to have predetermined dimensional relationship that will be identical to the dimensional relationship of the cap 122 of the piston 14 manufacturing as a product by machining the end surface 210 and the like as will be described later. In the present embodiment, the cap 164 as constructed in this manner is made of an aluminum alloy, i.e. a kind of a metal, and manufactured by the casting or the forging similarly to the main body member 164. In addition, FIG. 3 also illustrates the circumferential wall thickness of the cylinder portion 174, the circumferential wall thickness of the large diameter portion 194, the thickness of the bottom wall 192 and the like in an exaggerated manner for the purpose of facilitating understanding.

A process of fixing the cap member 164 to the main body member 162 will be described.

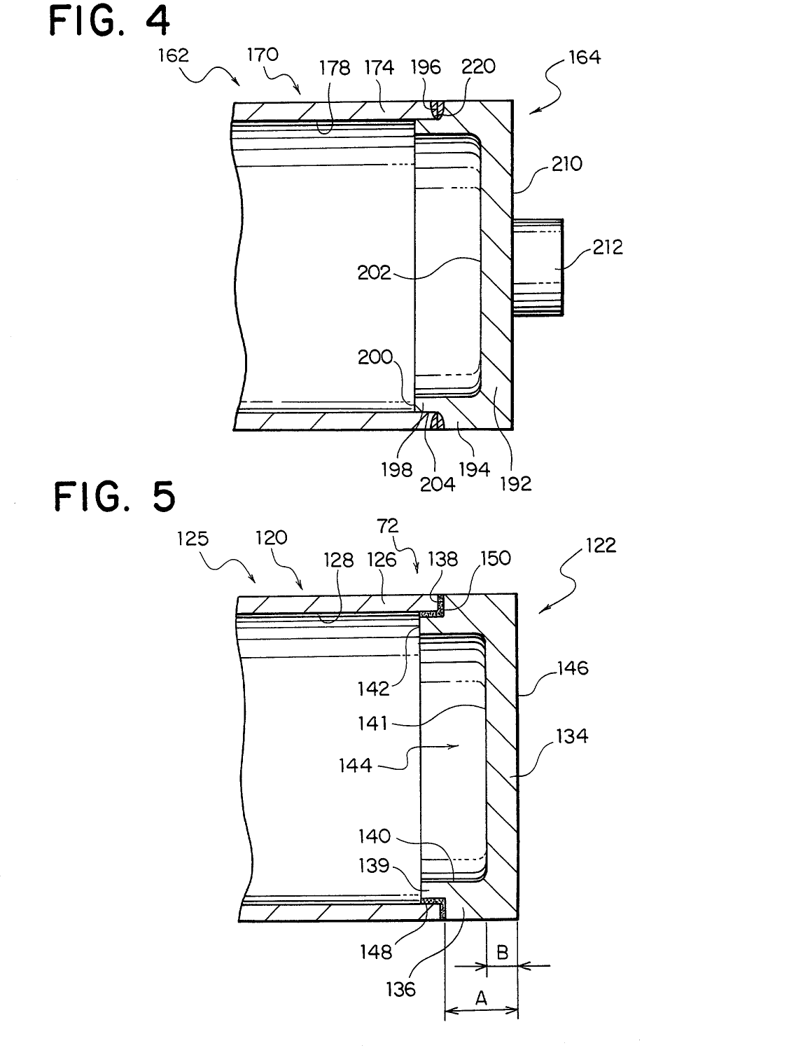

As shown in FIG. 4 in an exaggerated and enlarged manner, the cap 164 is coaxially aligned and inserted into the open side of the bottomed cylindrical portion 170 so that the outer circumferential surface 204 of the small diameter portion 198 is fitted to the inner circumferential surface 178. In a state in which the cap 164 is aligned with respect to the interior of the bottomed cylindrical portion 170 by the fitting between the inner circumferential surface 178 and the outer circumferential surface 204, the fitting advances further until the end surface 196 of the cap 164 is contacted with the open side end surface 220 of the cylinder portion 174, thereby restricting the fitting depth of the cap 164. In a state in which the end surface 220 is contacted with or located close to the end surface 196, an electron beam irradiating device of an electron beam welding machine not shown irradiates an electron beam so that these end surfaces 220 and 196 are welded together as welding surfaces. At this time, a pair of jigs (not shown) having an accommodating hole for accommodating the holder portion 212 of the cap 164 are used to hold and clamp the main body member 162 and the cap 164 from both sides, and in this state, the main body member 162 and the cap 164 are rotated about their axes by a rotation drive device while the electron beam is irradiated in the direction perpendicular to the axis of the main body member 162 (in the direction along the linear line parallel to the welding surfaces) onto the position corresponding to the welding surfaces. In this manner, the welding surfaces in an annular shape are welded to each other. Since the axial offset of the cap 164 with respect to the main body member 162 is positively prevented by the jigs, the welding can be effectively conducted. In the present embodiment, the welding reaches the inner circumferential edge of the open side end portion 220 of the bottomed cylindrical portion 170.

In the present embodiment, the irradiated point by the electron beam is moved circumferentially by rotating the single-headed piston manufacturing material 160. The electron beam irradiating device or the electron beam irradiated point per se may be moved circumferentially. The electron beam welding is a kind of beam welding, and other than this, laser beam welding may be used to connect these members.

After the two caps 164 are fixed to the main body members 162 in this manner, a cutting process is carried out onto the portion corresponding to the head portions 72, i.e. the plural portions including the bottomed cylindrical portions 170 of the main body members 162. First of all, center holes 224 (shown by two-dotted chain line in FIG. 3) are formed in the holder portions 212 provided to the two cap members 164, respectively. The centers are fitted to the center holes 224 for alignment, and the two holder portions 212 are held by chucks, respectively, and in this state, the rotation of the rotation drive device is transmitted to the caps 164 and the main body members 162, so that the processing is carried out thereon effectively.

Next, coating is carried out onto the portions including the outer circumferential surfaces of the bottomed cylindrical portions 170 of the main body members 162 to form, for example, a polytetrafluoroetheylene coating layer thereon. Subsequently, the holder portions 212 are removed from the caps 164 by cutting, and the end surfaces 210 are ground, and then a center-less grinding is applied to the outer circumferential surfaces and the like of the bottomed cylindrical portions 170 on which the coating layer is formed, thereby completing the head portions 72. Subsequently, the machining process is applied to the engagement portions 166 to remove the bridge portions 182 and form the recessed portions 114 (shown by two-dotted chain line in FIG. 3), which will be used to hold the shoes 76 when the piston 14 is manufactured as a product, thereby complete the engagement portions 70. Then, the material 160 is divided into two sections, and thus the two pistons 14 are obtained.

As can be seen from the foregoing description, the large diameter portion 136 and 194 construct the cylinder portion, and the small diameter portion 139 and 198 construct the fitting portion.

In the piston 14 thus manufactured, the welded portions between the end surfaces 138 and 150 is made remote from the portion (the boundary portion between the bottom wall 134 and the large diameter portion 136) where the stress is concentrated when the bottom wall 134 is elastically deformed three-dimensionally due to the gas pressure and the inertial force acting on the bottom wall 134 of the piston 14 during the compression process and the suction process. Therefore, the stress acting on the end surface 150 is close to a simple compression stress or tensile stress. Further, the rigidity of the cap 122 is increased by the cylindrical large diameter portion 136 formed to extend from the outer circumferential portion of the bottom wall 134. Accordingly, a maximum value of the stress acting on the end surface 150, particularly in the vicinity of the inner circumferential surface can be reduced. Since the maximum value of the stress acting on the end surface 150 can be reduced, the thickness of the cylinder portion 126 of the piston main body member 125 can be reduced accordingly, and the thickness of the bottom wall 134 of the cap 122 can be reduced to permit a relatively large elastic deformation. Consequently, it is possible to achieve the sufficient reduction in weight while securing the durability of the piston 14. More specifically, it was found from experiments that if the cap length A of the piston 14 is set to be about 1.5 times (5 mm) of the thickness B (3 mm) of the bottom wall 134 or about 2 times (7 mm), then the piston 14 can be effectively reduced in weight while having the necessary strength required, in particular, during compression process. Further, if the welding between the end surfaces 138 and 150 reaches the inner circumferential edge, the strength in welded portion is remarkably increased in comparison to a case where the welding is short in depth not to reach the inner circumferential edge. This is because not only is the welded area increased, but also it is possible to eliminate such a phenomenon that a non-welding portion behaves as a crack.

### Embodiments 2 to 6

The method of connecting the piston main body member to the closure member is not limited to the welding, and can be employed by various methods. Referring to FIGS. 5 to 9, other embodiments 2 to 6 will be respectively described. FIGS. 5 to 9 show only the portions different from those described with reference to FIGS. 1 to 4.

For example, the two members may be connected by adhesion. An example is shown in FIG. 5. Since the piston main body member, and the cap member serving as the closure member are the same in configuration to those of the embodiments shown in FIGS. 1 to 4, so that the same reference numerals are applied and the detailed description thereof is omitted here. As shown in FIG. 5, the cap 122 is fitted to the interior of the bottomed cylindrical portion 120 to such a depth that the end surface 138 is contacted with the open side end surface 150. The outer circumferential surface 148 of the small diameter portion 139 is fitted to the inner circumferential surface 128, and the end surfaces 138 and 150, and the inner circumferential surfaces 128 and the outer circumferential surfaces 148 are connected by adhesive. In FIG. 5, the thickness of the adhesive agent layer, the thickness of the circumferential wall of the cylinder portion 126 and the like are shown in an exaggerated manner. Prior to the fitting of the cap 122 to the bottomed cylindrical portion 120 of the piston main body member 125, the adhesive agent is applied onto the end surface 138 of the cap 122 and the outer circumferential surface 148 of the small diameter portion 139, and then the cap 122 is coaxially fitted to the bottomed cylindrical portion 120, and the adhesive agent is hardened in the state in which the end surfaces 138 and the 150 are contacted with each other, thereby firmly connecting these members together.

The adhesive agent may be applied to the inner circumferential surface 128 of the cylinder portion 126 and the open side end surface 150 thereof in place of the end surface 138 of the cap 122 and the outer circumferential surface 148 thereof, or may be applied to all of these portions. The adhesive agent may be a room temperature hardening type adhesive agent such as a methacrylate, an acrylate, and an acryl, or may be a thermosetting type adhesive agent such as an epoxy, a polyimide, a polyamide imide, and a phenol. A room temperature hardening type two-part adhesive agent such as an acryl may also be used. In the case where the two-part adhesive agent is used, a first fluid, i.e. an adhesive agent, is applied onto one of the main body member 162 and the cap 164, and a second fluid, i.e. a hardening promoting agent, is applied to the other. The two-part adhesive agent is constructed by a first fluid, i.e. the adhesive agent, and a second fluid, i.e. a hardening promoting agent, and by contact and mixing the adhesive agent and the hardening promoting agent together, the adhesive agent is hardened.

The similar effects as those described in connection with the former embodiment can be obtained by the present embodiment. Further, since the compression stress or the tensile stress acting on the adhesive agent layer between the end surfaces 138 and 150 are small, it is possible to effectively prevent the separation of the adhesive agent layer from developing from this portion, to thereby avoid the lowering of the durability of the hollow piston.

In the above embodiments, the inner circumferential surface 128 and the outer circumferential surface 148 are clearance-fitted to each other, but these surfaces may be tightly fitted to each other.

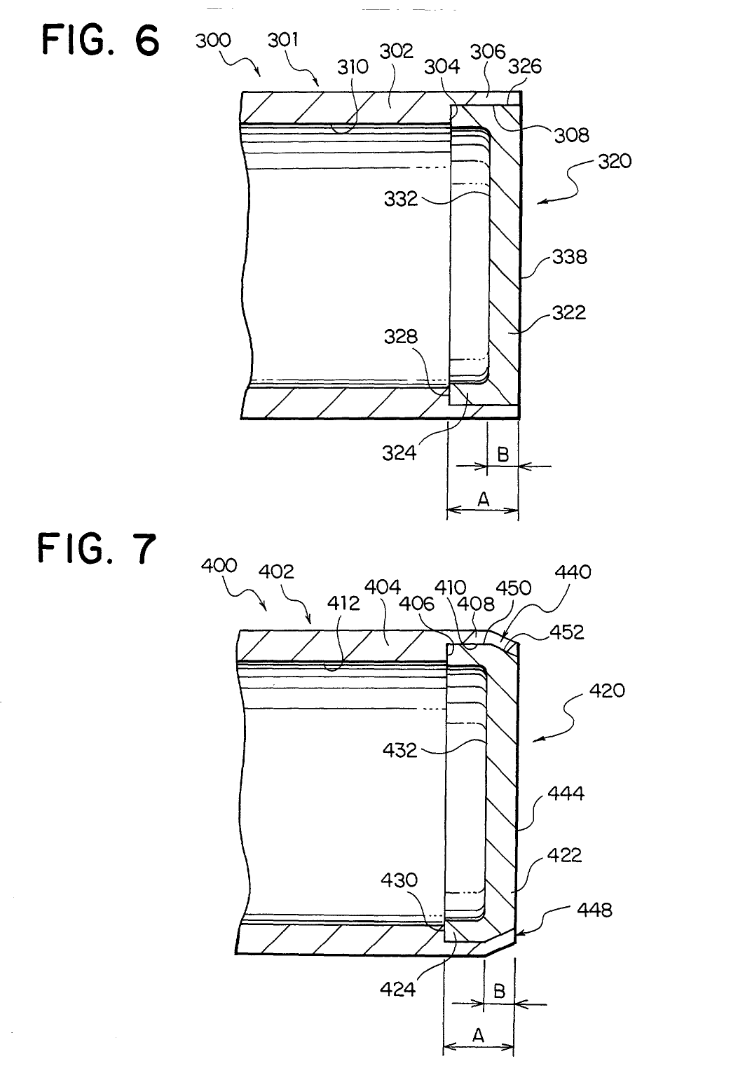

The piston main body member and the cap serving as the closure member may take various configurations, and FIG. 6 shows an example thereof. The bottomed cylindrical portion 301 of the piston main body member 300 shown in FIG. 6 are integrally provided with the cylinder portion 302 and the fitting portion 306 extending axially from the outer circumferential portion of the end surface 304 of the cylinder portion 302. The inner circumferential surface 308 of the fitting portion 306 is larger in diameter than the inner circumferential surface 310 of the cylinder portion 302.

The cap 320, serving as the closure member for closing the opening of the bottomed cylindrical portion 301, is provided with the planar plate-like bottom wall 322 and the cylinder portion 324 extending axially from the outer circumferential portion of the bottom wall 322. The diameter of the outer circumferential surface 326 of the cap 320 is slightly larger than the diameter of the inner circumferential surface 308 of the fitting portion 306, so that a negative fitting clearance is provided there between. The inner circumferential surface of the cylinder portion 324 and the inner surface of the bottom wall 322 define the recessed portion 332 opened to the end surface 328, thereby reducing the weight. Similarly as the aforementioned embodiments, the corner portion at the intersection between the inner circumferential surface of the recessed portion 322 and the inner surface thereof is rounded. The axial length A from the apex surface 338, i.e. the outer end surface of the bottom wall 322, to the end surface 328 is set to be 1.5 times or more of the thickness of the bottom wall 322, or 2 times or more thereof, similarly to the aforementioned embodiments.

Prior to the fitting of the cap 320 to the bottomed cylindrical portion 301, the adhesive agent is applied to the end face 328 of the cap 320 and the outer circumferential surface 326 thereof. Alternatively, the adhesive agent may be applied to the end surface 304 of the bottomed cylindrical portion 301 and the inner circumferential surface 308 of the fitting portion 306. After the application of the adhesive agent, the leading end portion, i.e. the cylinder portion 324, of the cap 320 is coaxially fitted into the bottomed cylindrical portion 301. The outer circumferential surface 326 of the cap 320 is tightly fitted to the inner circumferential surface 308 of the fitting portion 306, and by contact of the end surface 304 with the end surface 328, the fitting depth is restricted. The adhesive connects the end surfaces 304 and 328 together, and the inner circumferential surface 308 to the outer circumferential surface 326. Since the inner circumferential surface 308 and the outer circumferential surface 326 are tightly fitted to each other, the connection strength of these members can be increased, thereby effectively preventing the relative rotation, and the removal of the cap 320 from the bottomed cylindrical portion 301, as well as securing highly accurate coaxial alignment between the piston main body member 300 and the cap 320. In addition, such an adhesion effect can be expected that the adhesive agent in the clearance between these members is positively held by fine protrusions and recesses on the surfaces of these members.

The inner circumferential surface 308 and the outer circumferential surface 326 may be clearance-fitted to each other. In this case, the end surfaces 304 and 328 are adhered to each other, and the adhesive agent is filled into the fitting clearance between the inner circumferential surface 308 and the outer circumferential surface 326, thereby connecting these members together.

The piston main body member and the closure member may be connected to each other by caulking. FIG. 7 shows an example thereof. The bottomed cylindrical portion 402 of the piston main body member 400 is provided integrally with the cylinder portion 404 and the fitting portion 408 extending axially from the outer circumferential portion of the end surface 406 of the cylinder portion 404. The inner circumferential surface 410 of the fitting portion 408 is larger in diameter than the inner circumferential surface 412 of the cylinder portion 404. The cap 420, serving as the closure member for closing the opening of the bottomed cylindrical portion 402, is provided with the planar plate-like bottom wall 422, and the cylinder portion 424 extending axially from the outer circumferential portion of the bottom wall 422. The inner circumferential surface of the cylinder portion 424 and the inner surface of the bottom wall 422 define the recessed portion 432 opened to the end surface 430, thereby reducing the weight. The corner portion at the intersection between these inner circumferential surface and inner surface is rounded similarly to the aforementioned embodiments. A chamfered portion 448 is provided to a portion of the outer circumferential surface 440 of the cap 420 adjacent to the apex surface 444, i.e. the outer end surface of the bottom wall 422. The chamfered portion 448 is inclined to increase the diameter as it is located farther from the apex surface 444. By forming the chamfered portion 448, the outer circumferential surface 440 of the cap 420 has a straight outer circumferential surface 450 having such a diameter as to be fittable to the inner circumferential surface 410 of the fitting portion 408, and a tapered outer circumferential surface 452 that is continuous to the straight outer circumferential surface 450 and that is decreased in diameter as it becomes closer to the apex surface 444 from the end surface 430. The dimensional relationships, i.e. the thickness B of the bottom wall 422 and the axial length A from the end surface 430 of the bottom wall 422 to the apex surface 444 are set to be the same as those in the aforementioned embodiments.

The straight outer circumferential surface 450 of the cylinder portion 424 of the cap 420 is fitted to the inner circumferential surface 410 of the fitting portion 408 of the bottomed cylindrical portion 402, and by contact of the end surface 430 with the end surface 406, the fitting depth is restricted. In a state-in which the cap 420 is positioned within the inner circumferential surface 410 in this manner, the leading end portion of the fitting portion 408 is caulked (deformed) radially inwardly along the tapered outer circumferential surface 452 of the cap 420, thereby firmly connecting the piston main body member 400 and the cap 420 together. Alternatively, prior to the fitting of the cap 420 to the bottomed cylindrical portion 402, the adhesive agent is applied to the end surface 430 of the cap 420 and the straight outer circumferential surface 450 thereof. After the end surfaces 430 and 406 are contacted with each other, and the adhesive agent is hardened, the fitting portion 408 may be caulked. This makes it possible to more firmly fix the two members together. The adhesive agent may be applied to the end surface 406 of the bottomed cylindrical portion 402 and the inner circumferential surface 410 of the fitting portion 408. The kind of the adhesive agent which can be used is the same as that described in connection with the embodiment shown in FIG. 5.

By caulking of the leading end portion of the fitting portion 408 in this manner, the caulked portion is engaged with the chamfered portion 448 of the cap 420, thereby preventing the removal of the cap 420 from the fitting portion 408. In the case where the connection between the piston main body member 400 and the cap 420 is achieved only by caulking, the compression stress acting on the inner circumferential portion of the end surface 406, i.e. the contact surface of the cylinder portion 404, is made maximum if the bottom wall 422 of the cap 420 is deformed to be convex toward the interior of the bottomed cylindrical portion 402, but the provision of the cylinder portion 424 to the cap 420 can reduce this maximum compression stress. Accordingly, it is possible to realize the reduction of weight while securing the durability of the hollow piston. Further, in the case where not only the end surfaces 406 and 430 of the respective cylinder portions 404 and 424, but also the straight outer circumferential surface 450 of the cap 420 and the inner circumferential surface 410 of the fitting portion 408 are adhered to each other, the compression or tensile stress acting on the adhesive agent layer interposed between the end surfaces 406 and 430 is small, and therefore it is possible to prevent the separation of adhesive layer from being developed from this portion, thereby effectively preventing the lowering of the durability of the hollow piston.

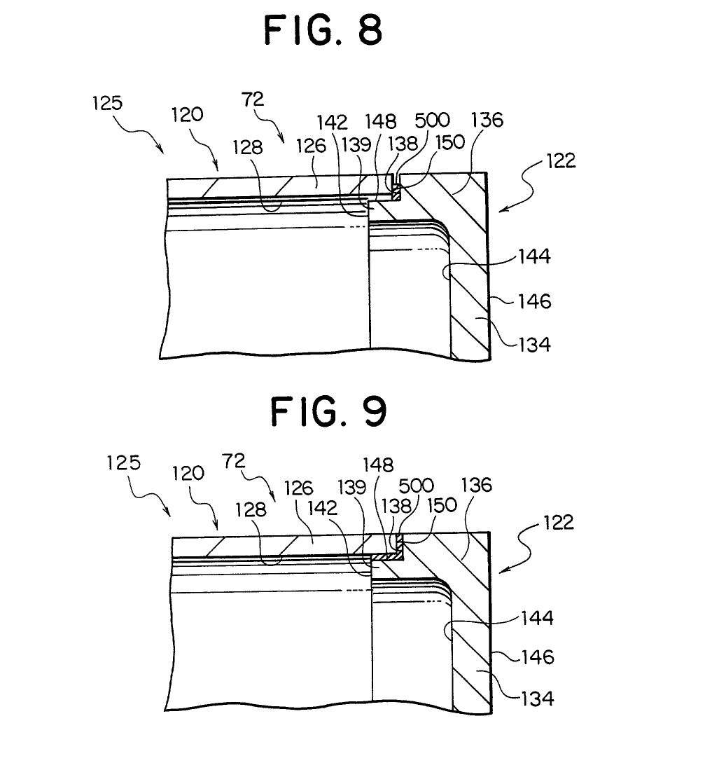

In place of the adhesive agent of the embodiment shown in FIG. 5, a brazing material may be used to connect the two members together by brazing. FIGS. 8 and 9 show an example thereof. As shown in FIG. 8. the small diameter portion 139 of the cap 122 is coaxially fitted into the bottomed cylindrical portion 120, and a brazing material 500 is interposed between the open side end surface 150 and the end surface 138. The brazing material 500 is formed of material having a melting point lower than melting points of the materials from which the bottomed cylindrical portion 120 and the cap 122 are formed. In the present embodiment, since the bottomed cylindrical portion 120 and the cap 122 are both formed of the aluminum alloy, the brazing material 500 is formed of Zn-Al-Cu group alloy (the melting point thereof is about 400° C.) lower in melting point than the aluminum alloy (500 to 550° C.). In a state in which the brazing material 500 is interposed between the end surface 150 and the end surface 138, the bottomed cylindrical portion 120 and the cap 122 are heated to the temperature equal to or higher than the melting point of the brazing material 500 while applying a depressing force to the cap 122 toward the bottomed cylindrical portion 120. Consequently, the brazing material 500 is melted to connect the end surfaces 150 and 139 together by brazing, and further, as shown in FIG. 9, the molten brazing material 500 is allowed to flow into the clearance between the inner circumferential surface 128 of the bottomed cylindrical portion 120 and the outer circumferential surface 148 of the small diameter portion 139 of the cap 122 to connect these inner circumferential surface 128 and outer circumferential surface 148 together by brazing. In place of the brazing material 500, a low melting point alloy such as a solder may be used to connect the two members.

The piston main body member and the closure member may be connected to each other by frictional pressure contact, and may be connected to each other by any arbitrary combination of the connection methods described above.

At least one of the main body member and the closure member may be formed of a material other than the aluminum alloy, for example, of a magnesium alloy. In the case where the piston main body member and the closure member are connected together by adhesion or caulking, the closure member may be formed of a resin suitable for these connection methods.

The piston manufacturing material may have a single piston main body member and a single closure member so that a single piston is obtained form the piston manufacturing material.

The swash-plate type compressor is not limited in construction to that described in connection with the above embodiments, and may take any other construction. For example, the capacity control valve 90 is not essential, and an open/close valve may be provided, which is opened and closed mechanically based on a differential pressure between the pressure of the discharge chamber 24 and the pressure in the swash plate chamber 86. In place of or in combination with the capacity control valve 90, an electromagnetic control valve similar to the capacity control valve 90 may be provided at a midway of the bleeding passage 100, or an open/close valve opened and closed mechanically based on a differential pressure between the pressure in the swash plate chamber 86 and the pressure in the suction chamber 22 may be provided.

The present invention may be applied to a double-headed piston having head portions at both sides of the engagement portion with which the swash plate is engaged. The present invention may also be applied to a piston for a capacity-fixed type swash-plate compressor.

The several embodiments of the present invention have been described in detail, but these embodiments are merely examples, and the present invention can be put into practice as various modified and/or improved forms obtained obviously or equivalently by one having an ordinary skill in the art.

What is claimed is:

1. A hollow piston for a compressor, comprising:
(a) a piston main body member including a bottomed cylindrical portion and an engagement portion to be engaged with a reciprocating drive device, the bottomed cylindrical portion having a bottom wall and a cylinder portion extending axially from an outer circumferential portion of the bottom wall, the engagement portion being integral with the bottom wall of the bottomed cylindrical portion; and
(b) a closure member connected to the piston main body member to close the bottomed cylindrical portion of the piston main body member, thereby defining a hollow head portion of a substantially hollow cylindrical shape integral with the engagement portion,
wherein the closure member is in the form of a bottomed cylindrical shape including a bottom wall, and a cylinder portion extending axially from an outer circumferential portion of the bottom wall of the closure member,
wherein both of the cylinder portions are connected to each other in a state in which an end surface of the cylinder portion of the closure member is contacted with an end surface of the cylinder portion of the piston main body member, and
wherein a length of the closure member, which is a distance from an outer end surface of the bottom wall of the closure member to the end surface of the cylinder portion of the closure member, is larger than a thickness of the bottom wall of the closure member, and is less than ½ of an axial length of the hollow head portion.

2. A hollow piston for the compressor according to claim 1, wherein the closure member includes a cylindrical fitting portion extending axially from an end surface inner circumferential portion of the cylinder portion, and an outer circumferential surface of the fitting portion is fitted to an inner circumferential surface of the cylinder portion of the piston main body member.

3. A hollow piston for the compressor according to claim 2, wherein the end surface of the cylinder portion of the piston main body member and the end surface of the cylinder portion of the closure member are welded to each other.

4. A hollow piston for the compressor according to claim 2, wherein by an adhesive agent, the end surface of the cylinder portion of the piston main body member and the end surface of the cylinder portion of the closure member are adhered to each other, and the outer circumferential surface of the fitting portion is adhered to the inner circumferential surface of the cylinder portion of the piston main body member.

5. A hollow piston for the compressor according to claim 2, wherein by a low melting point material lower in melting point than materials of the piston main body member and closure member, the end surface of the cylinder portion of the piston main body member and the end surface of the cylinder portion of the closure member are joined to each other, and the outer circumferential surface of the fitting portion is joined to the inner circumferential surface of the cylinder portion of the piston main body member.

6. A hollow piston for the compressor according to claim 1, wherein the piston main body member includes a cylindrical fitting portion extending axially from an outer circumferential portion of the end surface of the cylinder portion of the bottomed cylindrical portion, and an inner circumferential surface of the fitting portion and an outer circumferential surface of the closure member are fitted to each other.

7. A hollow piston for the compressor according to claim 6, wherein by an adhesive agent, the end surface of the cylinder portion of the piston main body member and the end surface of the cylinder portion of the closure member are adhered to each other, and the inner circumferential surface of the fitting portion is adhered to the outer circumferential surface of the closure member.

8. A hollow piston for the compressor according to claim 1, wherein an outer end surface circumferential edge of the bottom wall of the closure member is chamfered to provide a chamfered portion, and a leading end portion of the fitting portion is caulked onto the chamfered portion.

9. A hollow piston for the compressor according to claim 1, wherein a length of the closure member is 1.5 times or more of a thickness of the bottom wall of the closure member.

10. A hollow piston for the compressor according to claim 6, wherein a length of the closure member is 2 times or more of a thickness of the bottom wall of the closure member.

11. A hollow piston for the compressor according to claim 1, wherein a corner at an intersection between an inner surface of the bottom wall of the closure member in the form of the bottomed cylindrical shape and an inner circumferential surface of the cylinder portion thereof is rounded.

12. A method of manufacturing a hollow piston for a compressor, the hollow piston having an engagement portion to be engaged with a reciprocating drive device and a hollow head portion of a substantially hollow cylindrical shape, said method comprising the steps of:
forming the piston main body member including a bottomed cylindrical portion and an engagement portion, the bottomed cylindrical portion having a bottom wall and a cylinder portion extending axially from an outer circumferential portion of the bottom wall, the engagement portion being integral with the bottom wall of the bottomed cylindrical portion;
forming the closure member including a bottom wall and a cylinder portion extending axially from an outer circumferential portion of the bottom wall, a length of the closure member, which is a distance from an outer end surface of the bottom wall of the closure member to the end surface of the cylinder portion of the closure member, being larger than a thickness of the bottom wall of the closure member and;
connecting both of the cylinder portions to each other in a state in which an end surface of the cylinder portion of the closure member is contacted with an end surface of the cylinder portion of the piston main body member, the length of the closure member being less than ½ of an axial length of the hollow head portion.
